(19) United States
(12) Patent Application Publication
(10) Pub. No.: US 2009/0095092 A1
(43) Pub. Date: Apr. 16, 2009

(54) BOAT INCLUDING AUTOMATED WATER SAMPLING DEVICE AND METHOD OF USING SAME

(76) Inventors: Carl J. Lange, Uniondale, NY (US); Horace Walcott, Brooklyn, NY (US); Kelin Chen, Fresh Meadows, NY (US); Daniel Gray, Oakland Gardens, NY (US)

Correspondence Address: F. CHAU & ASSOCIATES, LLC, 130 WOODBURY ROAD, WOODBURY, NY, 11797, US

(21) Appl. No.: 12/210,586

(22) Filed: Sep. 15, 2008

Related U.S. Application Data
(60) Provisional application No. 60/972,671, filed on Sep. 14, 2007.

(51) Int. Cl. G01N 1/10

(52) U.S. Cl. 73/864

(57) ABSTRACT

A method for retrieving water samples from a body of water comprises positioning a remotely controlled boat on a body of water, moving the boat to a predetermined location on the body of water, lowering a probe attached to the boat into the body of water, wherein the probe includes a plurality of sample tubes contained therein, rotating a disc positioned above the plurality of sample tubes to line up a mouth of one of the sample tubes with an aperture to flow water into the sample tube.

### CROSS-REFERENCE TO RELATED APPLICATION

This application claims the benefit of Provisional Application Ser. No. 60/972,671, filed on Sep. 14, 2007, the contents of which are herein incorporated by reference in their entirety.

### BACKGROUND OF THE INVENTION

1. Technical Field

The present disclosure relates to an automated water sampling device for a boat, and a method of using same.

2. Discussion of the Related Art

Water sampling to test water quality of bodies of water, such as oceans, rivers, lakes, ponds and streams is vital to environmental studies to assess critical features, such as whether water is safe for consumption, swimming, and watering crops.

Known methods and devices for testing water require that a human tester manually retrieve samples of water by submerging a can including a vial or container to collect the sample. The human testers typically must position themselves at various points on the body of water to take single samples from different locations.

To ensure accuracy, the known devices and processes require that the testers change their location on the body of water for each sample they take so that a range of samples from different parts of the body of water can be collected. This process is cumbersome and time consuming.

Accordingly, there is need for a device to automatically or semi-automatically collect samples at various positions on a body of water.

### SUMMARY OF THE INVENTION

Embodiments of the present invention provide an automated water sampling boat capable to taking samples of water at diverse depths and latitudes, in bodies of water, such as, oceans, lakes, streams, ponds and rivers.

A method for retrieving water samples from a body of water, in accordance with an embodiment of the present invention, comprises positioning a remotely controlled boat on a body of water, moving the boat to a predetermined location on the body of water, lowering a probe attached to the boat into the body of water, wherein the probe includes a plurality of sample tubes contained therein, rotating a disc positioned above the plurality of sample tubes to line up a mouth of one of the sample tubes with an aperture to flow water into the sample tube.

A winch can be used to lower the probe into the body of water. The plurality of sample tubes are mounted below the rotating disc, which rotates about the vertical axis.

### BRIEF DESCRIPTION OF THE DRAWINGS

Exemplary embodiments of the present invention will be described below in more detail, with reference to the accompanying drawings, of which:

FIG. 1 is a schematic diagram of an automated water sampling boat, according to an embodiment of the present invention;

FIG. 2 is a schematic diagram of a solar hydrogen electrochemical reactor, according to an embodiment of the present invention; and

FIG. 3 is a side view of an automated water sampling boat, according to an embodiment of the present invention.

### DETAILED DESCRIPTION OF EXEMPLARY EMBODIMENTS

Exemplary embodiments of the present invention now will be described more fully hereinafter with reference to the accompanying drawings. This invention may, however, be embodied in many different forms and should not be construed as limited to the embodiments set forth herein.

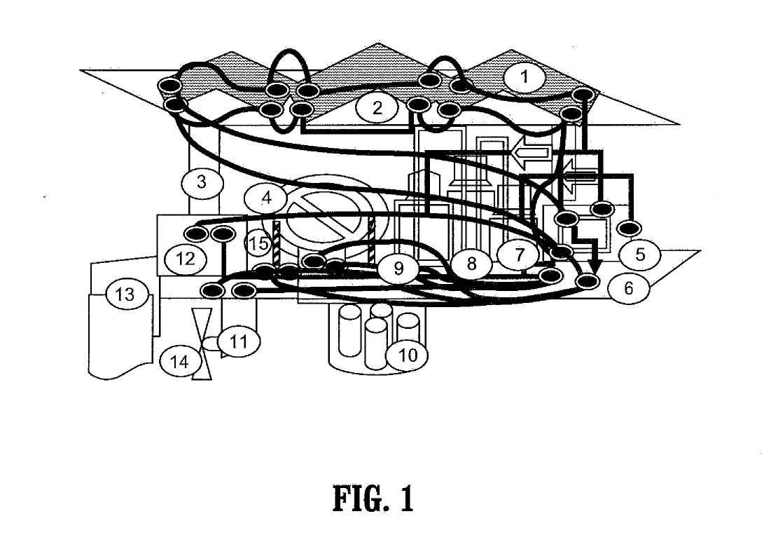

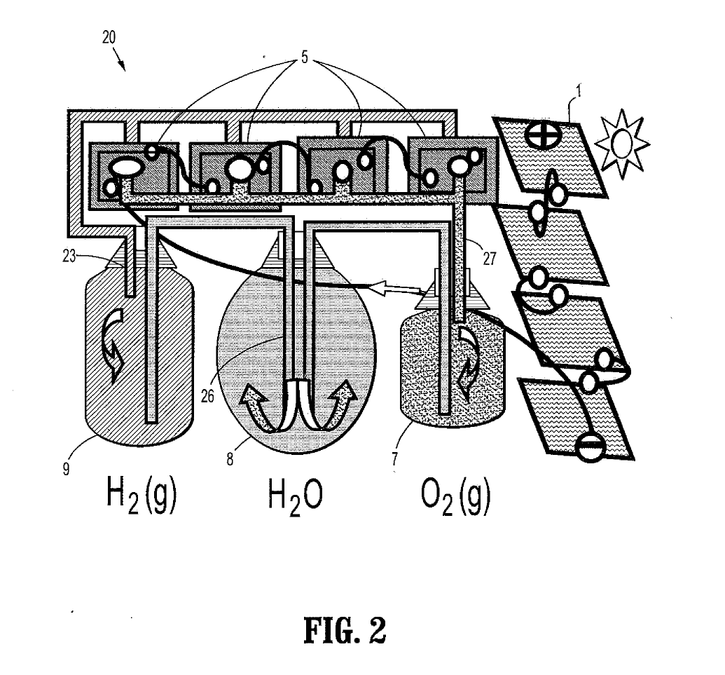

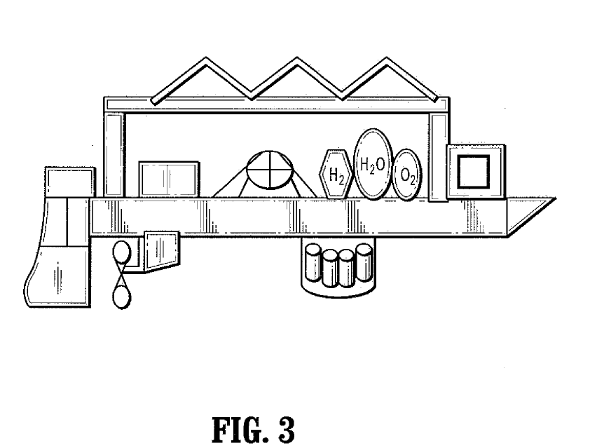

Referring to FIGS. 1-3, an automated water sampling boat includes a plurality of solar panels 1 positioned on a roof 2 of the boat. The roof 2 may be made of, for example, aluminum. The roof may be supported by a plurality of vertical supports or columns 3, which are connected to a hull 6. The boat includes a propeller support 11, a propeller 14 and a propeller motor 15. A shaft is used to connect the propeller motor 15 to the propeller. The boat also includes a rudder 13 and a rudder motor 12 for moving the rudder 13 to an appropriate position to steer the boat in a particular direction.

According to an embodiment, the boat is unmanned and is controlled from the shore by a multi-channel radio control unit. The multi-channel radio control unit may be used to remotely control all functions of the boat, including operation of the propeller 14 and propeller motor 15, operation of the rudder 13 and rudder motor 12, and operation of the winch 4. Alternatively, the functions of the boat may be pre-programmed to run a sampling operation controlled by a computer, and a global positioning system (GPS) may be utilized.

In operation, the boat is used to collect water samples at a variety of depths and latitudes in a body of water. A robotic winch 4, with a water sampling probe 10 attached thereto, lowers the water sampling probe 10, from below the boat, to a variety of depths to collect a plurality of water samples. The probe 10 includes a cylinder containing a plurality of detachable test tubes, such as, for example, four test-tubes, attached/mounted below a rotating disc, which rotates about the vertical axis. The disc when rotated can position the mouth of each test-tube below an aperture at the top of the cylinder through which water flows from a sub-surface segment of a body of water. The aperture is positioned over a single test-tube to take a sample, while the remaining test-tubes do not collect a sample.

The probe 10 can collect a plurality of individual samples in each of the plurality of test tubes at one site in a body of water. The probe 10 can also collect a plurality of individual samples from a plurality of different sites or depths.

The boat may be powered by a solar hydrogen reactor 20, including a plurality of solar panels 1, such as, for example, six (6) 3.0 V, 110 milliamp solar panels 1, wherein four of the solar panels are arranged in series with each other, and the remaining two of the solar panels are arranged in parallel. The solar panels 1 are connected with a plurality of proton exchange membranes (PEMs) 5, such as, four (4) or six (6) 3.0 V fuel cells including the PEMs, also arranged in series with each other. A water cylinder 8, made of, for example, plastic, is connected by tubing 26, such as plastic tubing, to an oxygen cylinder 7 and a hydrogen cylinder 9. The oxygen cylinder 7 is connected, via an oxygen outlet 22 made of, for example, plastic tubing, to the PEMs 5. The hydrogen cylinder 9 is connected, via a hydrogen outlet 23 made of, for example, plastic tubing, to the PEMs 5.

There are two cycles or phases governing the function of the fuel cell reactor; the electrolytic phase and the voltaic phase. The electrolytic phase is endothermic and the voltaic is exothermic.

During the electrolytic phase of operation of the fuel cell reactor 20, the collapsible water cylinder 8 contains no fluids and is maintained under negative pressure. Simultaneously, the oxygen and hydrogen cylinders 7, 9 are completely filled with water and air has been purged from the closed circuit fluid sub-system of the fuel cell reactor 20. Photons from sunlight, which project on the solar panels 1 release electrons from the solar panels. The electrons are conducted by leads to the plurality of PEMs 5. In the PEMs 5, water is split into hydrogen and oxygen. Hydrogen molecules are released from the cathode side of the PEM and oxygen is released from the anode side of the PEM. The hydrogen gas exiting through the hydrogen outlet 23 displaces the water in the hydrogen cylinder 9, and the displaced water is collected in the water cylinder 8, which is maintained under negative pressure. Water in the oxygen cylinder 7 is similarly displaced by oxygen gas exiting through the oxygen outlet 22, and subsequently collected in the water cylinder 8. The electrolytic phase is terminated when the hydrogen and oxygen cylinders 9, 7 are completely filled with hydrogen and oxygen, respectively. The current to the PEMs from the solar panels is then switched off.

During the voltaic phase of operation of the reactor 20, oxygen and hydrogen under atmospheric and hydrostatic pressure are injected into the PEMs 5, where they catalytically combine to produce water and electrical energy. The electrical energy is then used to operate the winch 4, the probe 10, propeller motor 15 and rudder motor 12, by remote control.

The hydrogen cylinder 9 may be, for example, a 1 L bottle to collect the hydrogen gas. The oxygen cylinder 7 may be, for example, a 0.5 L bottle used to collect the oxygen gas. The water cylinder 8 may be, for example, a 2 L bottle used to collect the water displaced from the oxygen bottle 7 and hydrogen bottle 9, when hydrogen and oxygen gas from the PEMs 5 displace the water stored in the oxygen and hydrogen bottles 7, 9.

Accordingly, light energy from the sun, when beamed on the solar panels is converted into electrical energy, and the electricity is then used to split the water in the PEMs 5 into hydrogen and oxygen. The water bottle 8 maintained under sub-atmospheric pressure pulls water displaced from the oxygen and hydrogen bottles 7, 9, as these are filled with oxygen and hydrogen gas. The hydrogen and oxygen are then catalytically combined in the PEMs 5 and the electrical energy generated used to power the boat.

During the electrolytic phase, energy from the sun is converted to electricity, which is used for the electrolysis of water into hydrogen and oxygen. In the voltaic phase, the stored hydrogen and oxygen are catalytically combined in the PEMs 5. The electrons released from this exothermic reaction can be used for work, including free energy for the operation of motors, such as motors 12 and 15, the winch 4 and/or a robotic arm.

The drone boat and its sub-components can be powered by, for example, solar electrical energy and solar hydrogen electrical energy. In utilizing solar energy, the solar panels convert the sunlight to electrical energy, which is used to power the motors and also stored in a rechargeable battery. The solar hydrogen electrical (sHe) energy is derived from the catalytic combination of hydrogen and oxygen in the PEMs 5.

The boat may use distilled water as a fuel. Alternatively, the boat and its motors may be powered by combustion or steam engines.

Although exemplary embodiments of the present invention have been described hereinabove, it should be understood that the present invention is not limited to these embodiments, but may be modified by those skilled in the art without departing from the spirit and scope of the present invention, as defined in the appended claims.

What is claimed is:

1. A method for retrieving water samples from a body of water, comprising:
positioning a remotely controlled boat on a body of water;
moving the boat to a predetermined location on the body of water;
lowering a probe attached to the boat into the body of water, wherein the probe includes a plurality of sample tubes contained therein;
rotating a disc positioned above the plurality of sample tubes to line up a mouth of one of the sample tubes with an aperture to flow water into the sample tube.

2. The method according to claim 1, wherein a winch lowers the probe into the body of water.

3. The method according to claim 2, wherein the plurality of sample tubes are mounted below the rotating disc, which rotates about the vertical axis.
